(19) United States
(12) Patent Application Publication
(10) Pub. No.: US 2015/0131853 A1
(43) Pub. Date: May 14, 2015

(54) STEREO MATCHING SYSTEM AND METHOD FOR GENERATING DISPARITY MAP USING SAME

(71) Applicant: ELECTRONICS AND TELECOMMUNICATIONS RESEARCH INSTITUTE, DAEJEON (KR)

(72) Inventors: Eul Gyoon LIM, Daejeon (KR); Dae Hwan HWANG, Daejeon (KR); Kwang Ho YANG, Daejeon (KR); Jae Il CHO, Daejeon (KR)

(21) Appl. No.: 14/309,834

(22) Filed: Jun. 19, 2014

(30) Foreign Application Priority Data
Nov. 8, 2013 (KR) 10-2013-0135377

(51) Int. Cl. G06T 7/00; G06K 9/00

(52) U.S. Cl. CPC G06T 7/0075; G06K 9/00355; G06T 2207/10012; G06T 2207/20228; G06T 2207/30201
USPC 382/103

(57) ABSTRACT

A stereo matching system comprising a face detection unit configured to detect a face area using either one of a reference image and a target image provided thereto to extract information about the detected face area and a support window setting unit configured to compare between the information about the detected face area by the face detection unit and a preset value to set the size of support window.

### RELATED APPLICATIONS

This application claims the benefit of Korean Patent Application No. 10-2013-0135377, filed on Nov. 8, 2013, which is hereby incorporated by reference as if fully set forth herein.

### FIELD OF THE INVENTION

The present invention relates to a stereo matching system, and more particularly, to a stereo matching system and a method for generating a disparity map using the same that are capable of setting a support window size through the detection of a face area and generating the disparity map based on the support window size.

### BACKGROUND OF THE INVENTION

In general, like the binocular disparity in an image seen by the left and right human eyes, there exists disparity in an image pair captured by two cameras that are arranged in parallel in a horizontal direction as the human eyes. For example, under the assumption that an image captured by a camera corresponding to a right eye is a reference image and another image captured by another camera corresponding to a left eye is a target image, when one point P_{R}(x,y) in the reference image and one point P_{T}(x+dₚ,y) in the target image are the same point on a subject, the disparity of the point P_{R}(x,y) is represented as dₚ.

In a real stereo matching system, the disparity of the point P_{R}(x,y) is obtained by calculating dissimilarities between the point P_{R}(x,y) and points in a limited range on an epipolar line of the point P_{R}(x,y) in the target image, i.e., disparity candidates (P_{T}(x+0,y)˜P_{T}(x+Dₘₐₓ,y)) and selecting the difference dₚ in coordinates in a horizontal direction to a point having the smallest dissimilarity.

The dissimilarity measure refers to a matching cost or a cost simply in a stereo matching field, and is frequently represented as the absolute difference between two pixel values or SAD (Sum of Absolute Difference) between the vicinities of two pixels, or is also represented as the hamming distance between the results of census transformations. Since the cost is a three-dimensional variable in terms of image coordinates (x,y) and a disparity candidate d, it may also be called a cost volume or a disparity space image (DSI).

The cost value of the disparity candidate of the point P_{R}(x,y) may also be calibrated by using the cost plane for the disparity dₚ of pixels adjacent to the point P_{R}(x,y) or a three-dimensional cost volume composed of pixels and disparities adjacent to the point P_{R}(x,y). Herein, the process of calibration using a sum or mean of adjacent cost values, or weighted average thereof is referred to as a cost aggregation.

The range of the adjacent pixels used in the process of aggregating the cost values is referred to as a support region, a support window, a kernal window, or a correlation window.

In technologies relating to the cost aggregation process, a first technology includes the method of shiftable windows to perform a matching nine costs of a support window having a 7×7 pixel size including the point P_{R}(x,y) with respect to an image having a size of 512×512 pixels to select an one best match while discarding bad matches caused by occlusion at a disparity boundary.

A second technology includes the method of multiple windows to reduce errors at the disparity boundary in a manner that a new cost is set as the selective summation of 5, 9, or 25 costs of different support windows having the same size that are arranged around the small window containing the point P_{R}(x,y). That is, the second technology is a method in which two support windows are added by selecting them from four support windows around a 7×9 window, four support windows are added by selecting them from eight support windows around a 5×5 window, four support windows and eight support windows are added by selecting them from the middle and outer of the ring of 24 support windows around a 3×5 window and then the added support windows are compared one another, thereby extracting a set of optimal multiple windows.

However, the foregoing technologies merely use the support windows and silent to disclose how to adjust the size of the support windows.

A third technology is a method to locate an optimal shape of a support window and an optimal size of the support window for each pixel. That is, the third technology can obtain a good enough result even if the shape of the support window is square by detecting the support window having the minimum cost from the support windows ranging from a size of l×l to a size of u×u. Since this technology detects only when the change in size is within +1, 0, or −1 with reference to the size of the optimal support window of adjacent pixels in order to reduce the detection time of the support window, it can determine the optimal size of the support window through the calculation of 6 times per pixel.

Fourth technology is a locally dynamic support-weight which uses a support weight in a pixel unit using a color similarity and geometric proximity between the pixels in a given support window. In this technology, the geometric proximity means that influence on a one pixel in a support window adjacent to the point P_{R}(x,y) (i.e., a reference support window) is exponentially in inverse proportion to the Euclidean distance from the point of the one pixel to the point P_{R}(x,y). This technology takes into account the geometric proximity with respect to the pixels within the support window of the point P_{T}(x+dₚ,y) (a target support window), as well as the reference support window.

In the fourth technology, a variable γₚ for controlling the proximity is proportional to the size of the support window and is set as 17.5 which is the radius of the support window in case of the support window having a 35×35 pixel size. As a result, it is possible to use a large enough support window in spite of unawareness of the optimal size of the optimal support window.

On the other hand, recently, a method that enables to reduce the amount of calculation workload in order to implement a real-time system, i.e., a research is being concentrated as to whether how much the size of the support window can be reduced.

### SUMMARY OF THE INVENTION

In view of the above, the present invention relates a stereo matching system to create distance information for stereoscopic recognition of gestures of human hands or human fingers, and the present invention provides a stereo matching system for acquiring distance information necessary for the recognition of gestures of human hands or human fingers by providing an approach for determining the influence on the size of a support window or pixels within the support window in order to solve the problem of the prior art which uses a fixed size of the support window that is specified in advance, and a method for generating a disparity map using the same.

Further, the present invention provides a stereo matching system that is capable of reducing an amount of calculation through variable adjustment of the size of the support window based on the detection of a face area and acquiring correct distance information through a disparity map and a method using the same.

In accordance with an embodiment of the present invention, there is provided a method for generating a disparity map in a stereo matching system, the method comprising, determining whether a face area is detected from either one of a reference image and a target image, extracting information about the detected face area when the face area is detected, setting the size of support window by comparing between the information about the detected face area and a predetermined value and defining the support window on the reference image or both of the reference image and the target image.

With the configuration of the present invention as mentioned above, advantages is provided in an aspect of robustly calculating the distance information of each individual hand/finger irrespective of the influence of a face of the relevant individual or a next person in spite of the change in the distance between a person and a hand/finger gesture recognition system for calculating the distance information for use of it by adjusting the size of the support window based on the face area or the proximity parameter.

Therefore, the present invention has an advantage to powerfully recognize the hand/finger gesture in depth direction using the distance information.

### BRIEF DESCRIPTION OF THE DRAWINGS

The above and other objects and features of the present invention will become apparent from the following description of the embodiments given in conjunction with the accompanying drawings, in which:

FIG. 1 is a block diagram of a stereo matching system based on a variable support window in accordance with an embodiment of the present invention;

FIG. 2 is a flow chart illustrating a process of producing a disparity map in a stereo matching system in accordance with an embodiment of the present invention;

FIG. 3 is a block diagram of a stereo matching system to which a variable support window is applied in accordance with another embodiment of the present invention;

FIG. 4 is a flow chart illustrating a process of producing a disparity map in a stereo matching system in accordance with another embodiment of the present invention;

FIG. 5 is a block diagram of a stereo matching system in accordance with further another embodiment of the present invention; and

FIG. 6 is a flow chart illustrating a process of producing a disparity map in a stereo matching system in accordance with further another embodiment of the present invention.

FIG. 7 is a block diagram of a stereo matching system implemented in a computer system in accordance with an embodiment of the present invention.

### DETAILED DESCRIPTION OF THE EMBODIMENTS

The advantages and features of embodiments and methods of accomplishing these will be clearly understood from the following described embodiments taken in conjunction with the accompanying drawings. However, embodiments are not limited to those embodiments and may be implemented in various forms. It should be noted that the present embodiments are provided to make a full disclosure and also to allow those skilled in the art to know the full range of the embodiments. Therefore, embodiments are to be defined only by the scope of the appended claims. Further, like reference numerals refer to like elements throughout the specification.

In the following description, well-known functions or constitutions will not be described in detail if they would unnecessarily obscure the embodiments of the invention. Further, the terminologies to be described below are defined in consideration of functions in the invention and may vary depending on a user's or operator's intention or practice. Accordingly, the definition may be made on a basis of the content throughout the specification.

Hereafter, the embodiment of the present invention will be described with reference to the accompanying drawings.

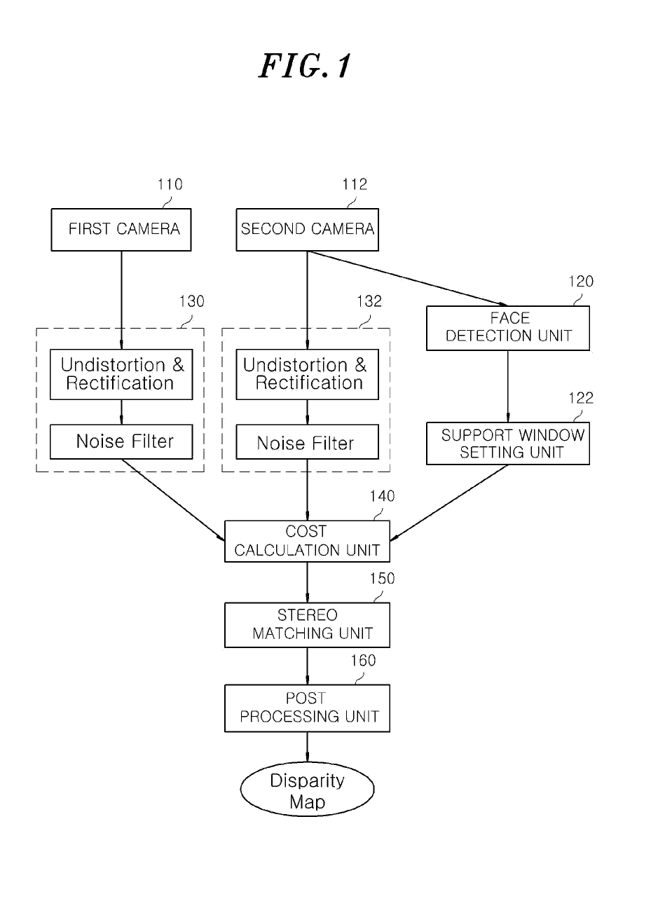

FIG. 1 is a block diagram of a stereo matching system based on a variable support window in accordance with an embodiment of the present invention.

As shown in FIG. 1, a stereo matching system may include a first camera 110, a second camera 112, a face detection unit 120, a support window setting unit 122, a first image processing unit 130, a second image processing unit 132, a cost calculation unit 140, a stereo matching unit 150, and a post processing unit 160.

The first and second cameras 110 and 112 serve to provide images or videos necessary for stereo matching. For example, the first camera 110 may capture a left image and the second camera may capture a right image.

In the following description, for the sake of convenient explanation, the image provided from the second camera 112 to capture the right image is defined as a reference image and the image provided from the first camera 110 to capture the left image is defined as a target image.

The face detection unit 120 may detect a face area in the image from the second camera 112, i.e., the reference image and extract information on the face area based on the detected face area. The extracted information on the face area information may be provided to the support window setting unit 122. In this case, the examples of the face area information may be, for example, a face size, a face location, a probability value, and the like, but not limited thereto. Following is a description on how the face detection unit 120 detects the face area and extracts the face area information.

The face detection unit 120 may have a probability value database obtained by transforming individual face images of a W×W pixel size and image data that have the same size but not a human face into images robust to lighting change using an MCT (Modified Census Transform) technique and calculating probability values that the image data of which particular pixel has a particular value will not have a face image. For example, when a 3×3 MCT is performed with respect to image data of a 20×20 pixel size, because of yielding 512 (=2⁹) MCT values per one pixel and one probability value per one MCT value, 512 probability value databases can be produced for each of total 400 pixels.

An input image is transformed using the same image transformation technique as described above and areas of the same size are defined as an ROI (Region of Interest) in the transformed image. Thereafter, it is checked whether a sum value H that totals all probability values for pixels in an ROI is less than a threshold. When the sum value H is less than the threshold, it is determined that the relevant ROI falls within a face area. The determination is made by shifting the ROI on one pixel basis in horizontal and vertical directions across the transformed input image. Thereafter, the transformed image is scaled to a ratio of 1/s, of which process is repeated.

During the foregoing process, several ROIs in which a face area is slightly shifted may be detected. Among the several ROIs which have an overlapping portion more than a predetermined area (e.g., ¼ of the face area), one ROI having a lowest sum value H is selected and the remaining ROIs are not moved to the next step.

In this case, the ROIs determined to have the face area may differ for the respective frames. This is because of a false detection. In order to prevent the false detection, the ROIs that are placed at the same reference position and have the same reduction ratio over a succession of at least three frames are identified as the face area and information about the identified ROIs are obtained.

Reference coordinates of the face area and the size of the face area (sW×sW) can be obtained by using the reference coordinates of an ROI that is identified as the face area and the reduction ratio 1/s.

Meanwhile, the process of detecting the face area and extraction information about the face area are only an illustrative example, and it will be apparent to those skilled in the art that various types of techniques for detecting a face area and methods for extracting information about the face area may be possible.

The support window setting unit 122 may store a preset value, i.e., a default size of a support window in advance and set a size of the support window based on whether the face area is detected or not, the information about the face area and the default size of the support window.

Specifically, if the face area is detected, the support window setting unit 122 may compare the size of the face area with the default size of the support window and set either one having the smaller size of the two as the size of the support window. However, when no face area is detected, the support window setting unit 122 may set the default size of the support window as the size of the support window.

Information about the size of the support window may be provided to the cost calculation unit 140.

In the meantime, the target image inputted from the first camera 110 may be passed through the first processing unit 130 and then provided to the cost calculation unit 140. The reference image inputted from the second camera 112 may be passed through the second processing unit 132 and then provided to the cost calculation unit 140.

The first and second image processing units 130 and 132 may have an undistortion and rectification processor and a noise filter. The undistortion and rectification processor and the noise filter may calibrate lens distortion components included in the camera image and the influence caused by the alignment error between the stereo cameras to ensure that the search range of a point corresponding to the point P_{R}(x,y) on the reference image is limited to the same horizontal scanning line on the target image.

The noise filter is used to remove noise included during the process of removing and rectifying the noise and/or the undistortion, but may be omitted if the noise becomes not a problem.

The target image and the reference image that are processed through the first processing unit 130 and the second processing unit 132 are then provided to the cost calculation unit 140.

The cost calculation unit 140 defines on the support window to the reference image or the reference and target images in accordance with the size of support window that is set by the support window setting unit 122 and calculates the cost values based on the defined support window. The method to calculate the cost values may include an area-based cost evaluation method such as an SAD (Sum of Absolute Difference), an SSD (Sum of Squared Difference), etc., but is not limited thereto.

The stereo matching unit 150, which is implemented on a basis of a stereo matching algorithm such as a WTA (Winner Takes All), BP (Belief Propagation), DP (Dynamic Programming), or the like, produces a disparity map using the cost value.

The post processing unit 160 serves to supplement the disparity map produced from the result of the stereo matching and may utilize a variety of techniques such as sub-pixel disparity estimation, median filtering, or the like, but is not limited thereto.

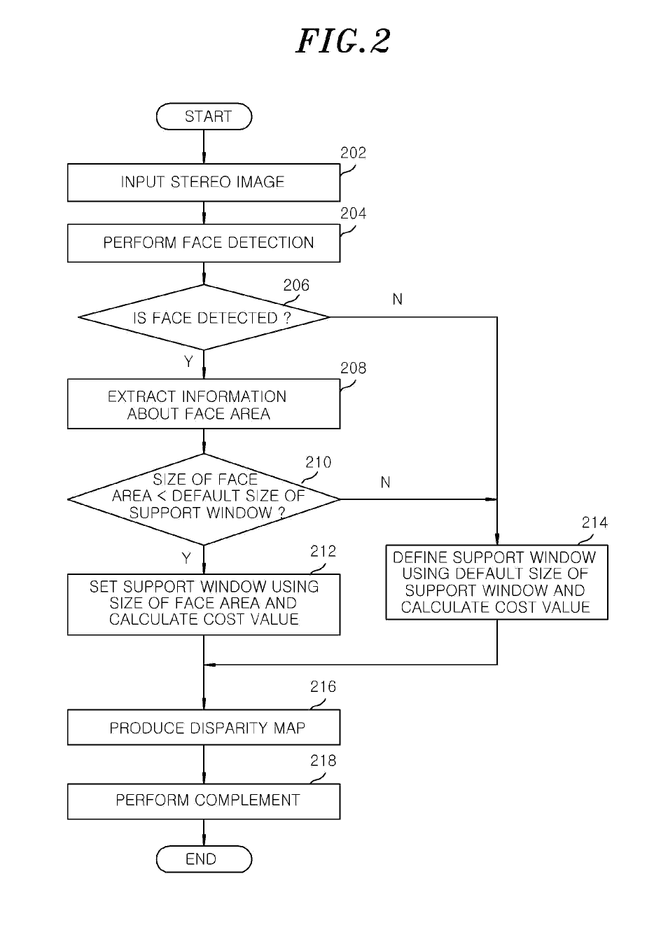

The process of the stereo matching system that produces a disparity map of FIG. 1 will be described with reference to FIG. 2.

FIG. 2 is a flow chart illustrating a process of producing a disparity map in the stereo matching system in accordance with an embodiment of the present invention.

As illustrated in drawing, when a stereo image, i.e., the images from the first and second cameras 110 and 112 are input (Block 202), the face detection unit 120 performs a face detection using the reference image, i.e., the image inputted from the second camera 112 (Block 204).

Next, the face detection unit 120 checks whether a face is detected from the reference image (Block 206).

As a result of the determination of Block 206, when the face is detected, the face detection unit 120 extracts information about the face area such as a size of the face area, location of the face area and probability value (Block 208). The extracted information is then provided to the support window setting unit 122.

The support window setting unit 122 determines whether the size of the face area is less than the default size of the support window (Block 210).

As a result of the determination of Block 210, when the size of the face area is less than the default size of support window, the size of the face area is set as the size of support window, which will then be provided to the cost calculation unit 140. Therefore, the cost calculation unit 140 defines the support window on the reference image or both of the reference image and the target image in accordance with the size of the face area and then calculates the cost value based on the defined support window (Block 212).

However, as a result of the determination of Block 210, when the size of the face area is larger than or equal to the default size of support window, the default size of support window is outputted to the cost calculation unit 140. Therefore, the cost calculation unit 140 defines the support window on the reference image or both of the reference image and the target image in accordance with the default size of support window and calculates the cost values based on the defined support window (Block 214).

Meanwhile, as a result of the determination of Block 206, when the face is not detected, the process goes to Block 214 to carry out the aforementioned operation.

The cost value calculated through the foregoing operations is then provided to the stereo matching unit 150 where a stereo matching algorithm is applied to the cost value to thereby produce a disparity map (Block 216).

Thereafter, the post processing unit 160 performs a post processing to complement the disparity map that is produced from the stereo matching (Block 218).

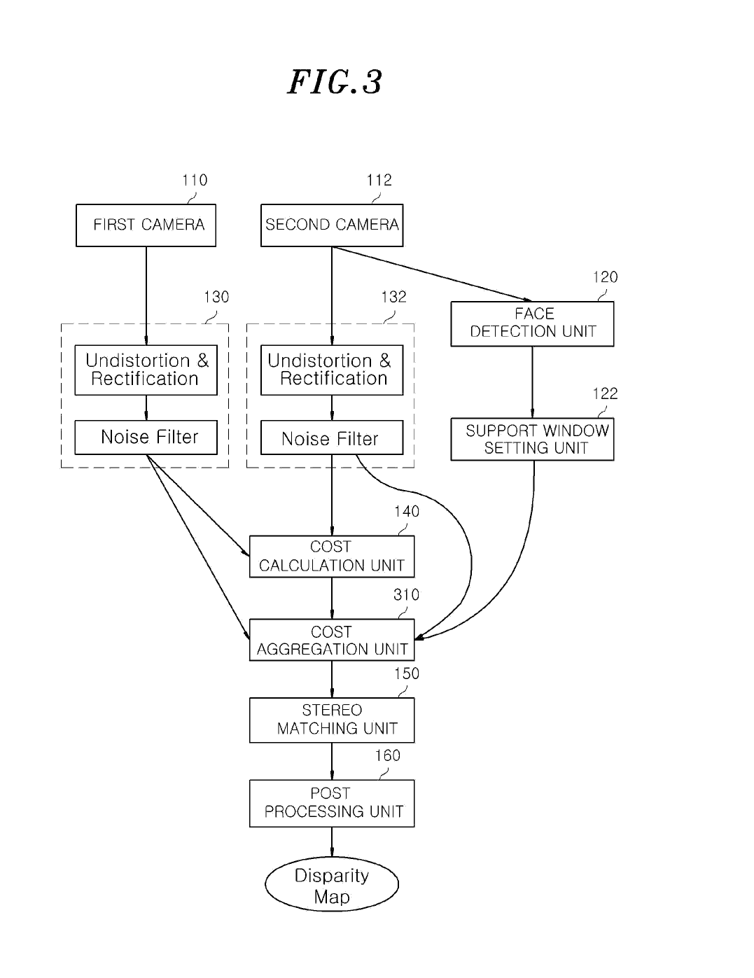

Meanwhile, although the embodiment of the present invention has been described and shown that the cost calculation unit 140 calculates the cost value in accordance with the size of the support window, it is understood that the size of the support window can be dynamically determined during the aggregation of all the cost values that are calculated between the reference image and the target image before, which will be discussed with reference to FIG. 3.

FIG. 3 is a block diagram of a stereo matching system to which a variable support window is applied in accordance with another embodiment of the present invention. It is note that the stereo matching system of FIG. 3 has the same configuration as shown in FIG. 1 except that a cost aggregation unit 310 is additionally connected to the cost calculation unit 140 and the support window setting unit 122.

In FIG. 3, the cost calculation unit 140 calculates the cost values between the reference image and the target image, for example, by using a hamming distance value of the results of a window-based census transformation as well as an AD, Truncated AD, or the like. The calculated cost values are then provided to the cost aggregation unit 310.

In this configuration of the present invention, the support window setting unit 122 provides a size of the support window set based on whether the face area is detected or not, the information about the face area and the default size of the support window to the cost aggregation unit 310.

The cost aggregation unit 310 defines the support window on the reference image or both of the reference image and the target image in accordance with the size of the support window provided from the support window setting unit 122 and aggregates the cost values. In this case, the radius of the support window may be defined by applying a proximity parameter.

On the other hand, in case where the cost aggregation unit 310 may aggregate the costs using a bilateral filter algorithm, the size of support window and the proximity parameter may be changed in a variable manner accordingly.

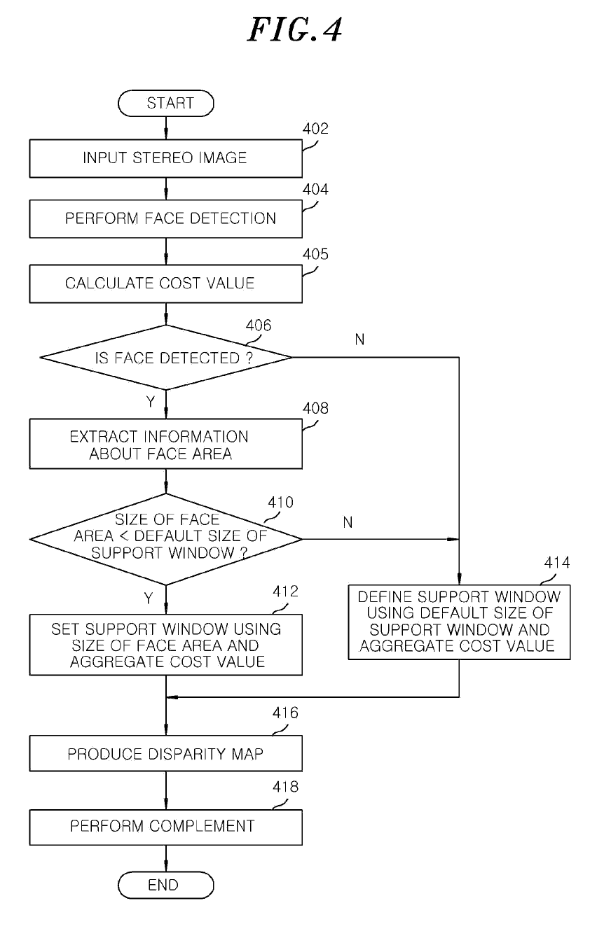

The process of the stereo matching system of FIG. 3 that produces the disparity map will be described with reference to FIG. 4.

FIG. 4 is a flow chart illustrating a process of producing a disparity map in the stereo matching system in accordance with another embodiment of the present invention.

As shown, when a stereo image, i.e., the images from the first and second cameras 110 and 112 are input (Block 402), the face detection unit 120 performs a face detection using the reference image, i.e., the image inputted from the second camera 112 (Block 404). At this time, the cost calculation unit 140 calculates a cost value between the reference image and the target image to provide the calculated cost values to the cost aggregation unit 310 (Block 405).

Next, the face detection unit 120 checks whether a face is detected from the reference image (Block 406).

As a result of the determination of Block 406, when the face is detected, the face detection unit 120 extracts information about the face area such as a size and location of the face area, probability value, etc. (Block 408). The extracted information is then provided to the support window setting unit 122.

The support window setting unit 122 determines whether the size of the face area is less than the default size of the support window (Block 410).

As a result of the determination of Block 410, when the size of the face area is less than the default size of support window, the size of the face area is set as the size of support window, which will then be provided to the cost aggregation unit 310. Therefore, the cost aggregation unit 310 defines the support window on the reference image or both of the reference image and the target image in accordance with the size of the face area and then aggregates the cost values within the defined support window (Block 412).

However, as a result of the determination of Block 410, when the size of the face area is larger than or equal to the default size of support window, the default size of support window is outputted to the cost aggregation unit 310. Therefore, the cost aggregation unit 310 defines the support window on the reference image or both of the reference image and the target image in accordance with the default size of support window and aggregates the cost values within the defined support window (Block 414).

Meanwhile, as a result of the determination of Block 406, when the face is not detected, the process goes to Block 414 to proceed with the aforementioned operation.

The cost value aggregated through the foregoing operations is then provided to the stereo matching unit 150, and the stereo matching unit 150 applies a stereo matching algorithm to the aggregated cost value, thereby producing a disparity map (Block 416).

Thereafter, the post processing unit 160 performs a post processing to complement the disparity map that is produced from the stereo matching (Block 418).

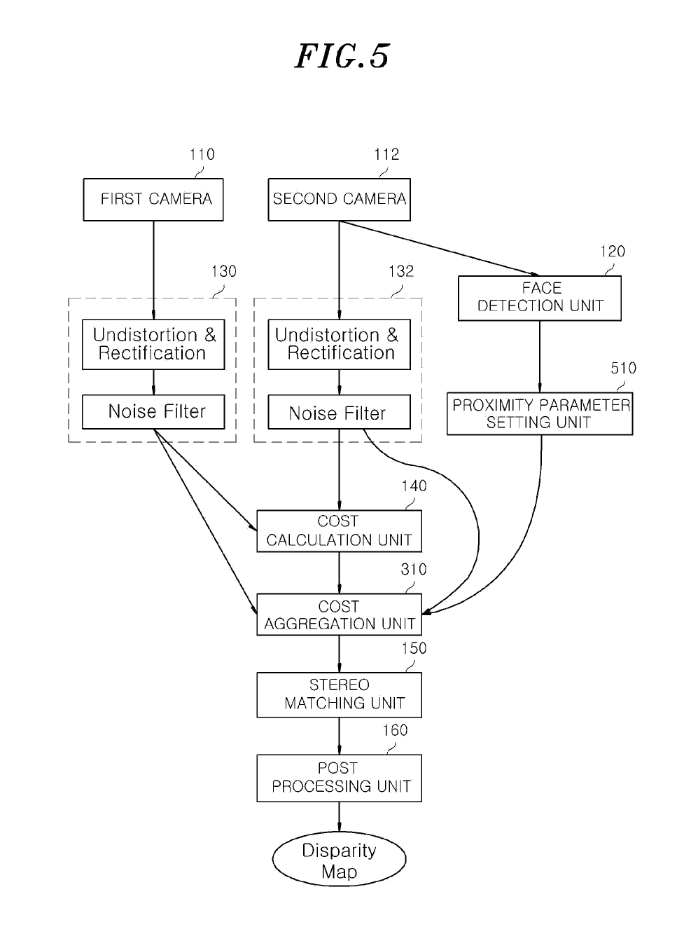

Meanwhile, in case where the dynamic change in the size of the support window is not easy, the cost aggregation can be performed depending on the dynamic change in the proximity parameter through the face detection, which will be discussed with reference to FIG. 5.

FIG. 5 is a block diagram of a stereo matching system in accordance with further another embodiment of the present invention. It is noted that the stereo matching system of FIG. 5 has the same configuration as shown in FIG. 3 except that a proximity parameter setting unit 510 is substituted for the support window setting unit 122.

In stereo matching system of further another embodiment, if the face detection unit 120 fails to detect the face area, the proximity parameter setting unit 510 provides a preset value of a proximity parameter to the cost aggregation unit 310 as its output, and otherwise compares between the radius of the size of face area that is acquired through the face detection and the preset value of the proximity parameter to select the smaller one of the two, which will then be provided to the cost aggregation unit 310.

The cost aggregation unit 310 then defines the support window on the reference image or both of the reference image and the target image in accordance with a preset size of support window and aggregates the cost values in the support window that is defined by using the proximity parameter value from the proximity parameter setting unit 510. In this case, the proximity parameter value is the output value from the proximity parameter setting unit 510.

As set forth above, the proximity parameter value that will be used in aggregation of the cost values is fixed through the comparison between the size of the face area and the preset value of the proximity parameter. Therefore, because the proximity parameter value also becomes small depending on the size of the detected face is small; the influence on the costs of the pixels distant from the center pixel becomes relatively less than when the size of the detected face is large.

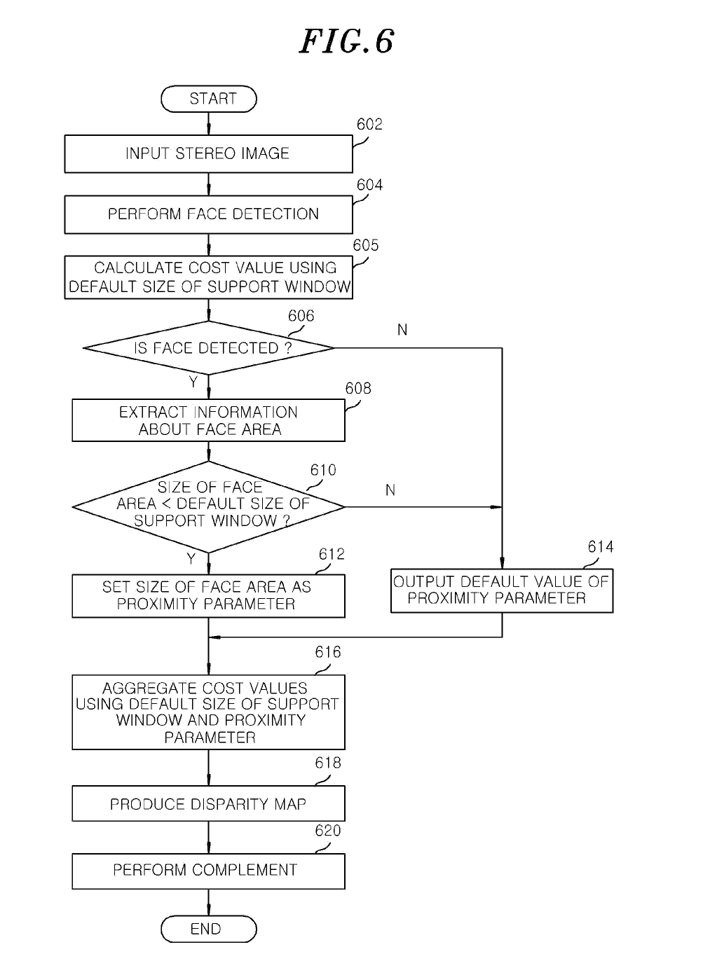

The process of the stereo matching system of FIG. 5 that produces the disparity map will be described with reference to FIG. 6.

FIG. 6 is a flow chart illustrating a process of producing a disparity map in the stereo matching system in accordance with further another embodiment of the present invention.

As illustrated in this drawing, when a stereo image, i.e., the images from the first and second cameras 110 and 112 are input (Block 602), the face detection unit 120 performs a face detection using the reference image, i.e., the image inputted from the second camera 112 (Block 604). At this time, the cost calculation unit 140 calculates a cost value between the reference image and the target image using a default size of support window to provide the calculated cost value to the cost aggregation unit 310 (Block 605).

Next, the face detection unit 120 checks whether a face is detected from the reference image (Block 606).

As a result of the determination of Block 606, when the face is detected, the face detection unit 120 extracts information about the face area such as a size and location of the face area, probability value, etc. (Block 608). The extracted information is then provided to the proximity parameter setting unit 510.

The proximity parameter setting unit 510 determines whether the size of the face area is less than the default value of proximity parameter (Block 610).

As a result of the determination of Block 610, when the size of the face area is less than the default value of proximity parameter, the size of the face area is set as a proximity parameter value (Block 612), which will then be provided to the cost aggregation unit 310. Therefore, the cost aggregation unit 310 defines the support window on the reference image or both of the reference image and the target image in accordance with a default size of the face area and then aggregates the cost values within the defined support window using the proximity parameter value provided from the proximity parameter setting unit 510 (Block 616).

However, as a result of the determination of Block 610, when the size of the face area is larger than or equal to the default value of proximity parameter, the default value of proximity parameter is outputted to the cost aggregation unit 310 (Block 614). Therefore, the cost aggregation unit 310 defines the support window on the reference image or both of the reference image and the target image in accordance with the default size of support window and aggregates the cost values within the defined support window using the default value of proximity parameter (Block 414).

Meanwhile, as a result of the determination of Block 606, when the face is not detected, the process goes to Block 614 to proceed with the aforementioned operation.

The cost value aggregated through the foregoing operations is then provided to the stereo matching unit 150, and the stereo matching unit 150 applies a stereo matching algorithm to the aggregated cost value, thereby producing a disparity map (Block 618).

Thereafter, the post processing unit 160 performs a post processing to complement the disparity map that is produced from the stereo matching (Block 620).

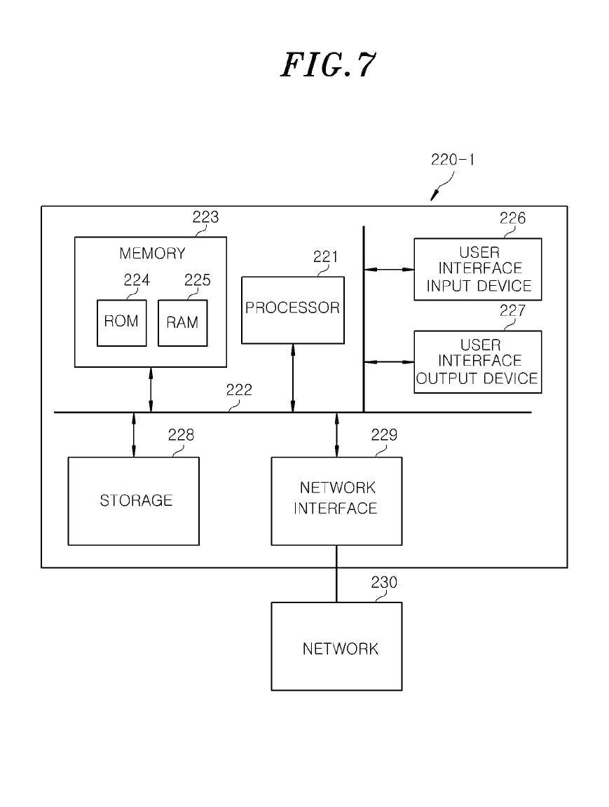

An embodiment of the present invention may be implemented in a computer system, e.g., as a computer readable medium. As shown in in FIG. 7, a computer system 220-1 may include one or more of a processor 221, a memory 223, a user input device 226, a user output device 227, and a storage 228, each of which communicates through a bus 222. The computer system 220-1 may also include a network interface 229 that is coupled to a network 230. The processor 221 may be a central processing unit (CPU) or a semiconductor device that executes processing instructions stored in the memory 223 and/or the storage 228. The memory 223 and the storage 228 may include various forms of volatile or non-volatile storage media. For example, the memory may include a read-only memory (ROM) 224 and a random access memory (RAM) 225.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

While the description of the present invention has been made to the exemplary embodiments, various changes and modifications may be made without departing from the scope of the invention. Therefore, the scope of the present invention should be defined by the appended claims rather than by the foregoing embodiments.

What is claimed is:

1. A stereo matching system comprising:
a face detection unit configured to detect a face area using either one of a reference image and a target image provided thereto to extract information about the detected face area; and
a support window setting unit configured to compare between the information about the detected face area by the face detection unit and a preset value to set the size of support window.

2. The stereo matching system of claim 1, further comprising:
a cost calculation unit configured to define the support window on the reference image or both of the reference image and the target image depending on the size of the defined support window and to calculate a cost value based on the defined support window.

3. The stereo matching system of claim 2, wherein the support window setting unit determines a predetermined value as the size of support window when the face area is not detected or when the size of face area is larger than the predetermined value.

4. The stereo matching system of claim 2, wherein the cost calculation unit calculates the cost value depending on the size of the defined support window using an area-based cost estimation method including an SAD (Sum of Absolute Difference) or an SSD (Sum of Squared Difference).

5. The stereo matching system of claim 1, further comprising:
a cost aggregation unit configured to define the support window on the reference image or both of the reference image and the target image depending on the size of the defined support window and to aggregate the cost values,
wherein the cost aggregation unit fixes the radius of the support window as a proximity parameter value.

6. The stereo matching system of claim 1, further comprising:
a proximity parameter setting unit configured to set a proximity parameter through the comparison of the information about the detected face area from the face detection unit and a predetermined value.

7. The stereo matching system of claim 6, wherein further comprising:
a proximity parameter setting unit sets the proximity parameter as the predetermined value when the information about the detected face area is not received from the face detection unit or when the size of the face area is larger than the predetermined value.

8. A method for generating a disparity map in a stereo matching system, the method comprising:
determining whether a face area is detected from either one of a reference image and a target image;
extracting information about the detected face area when the face area is detected;
setting the size of support window by comparing between the information about the detected face area and a predetermined value; and
defining the support window on the reference image or both of the reference image and the target image.

9. The method of claim 8, further comprising:
calculating a cost value based on the size of the defined support window.

10. The method of claim 8, further comprising:
aggregating cost values based on the size of the defined support window.

11. The method of claim 10, wherein said aggregating the cost values comprises:
aggregating the cost values after the radius of the support window is set using a proximity parameter.

12. The method of claim 8, further comprising:
setting the proximity parameter by comparing between the information about face area and a predetermined value.

13. The method of claim 12, said setting the proximity parameter comprises:
setting the predetermined value as the proximity parameter when the size of the face area is larger than the predetermined value or when the face area is not detected.
